(19) United States
(12) Patent Application Publication
(10) Pub. No.: US 2007/0220002 A1
(43) Pub. Date: Sep. 20, 2007

(54) Dynamic server configuration for managing high volume traffic

(75) Inventors: Catalin Teodorescu, Shoreline, WA (US); Alexandru Indrei, Seattle, WA (US); Bud Albers, Woodinville, WA (US); Jeffrey Wallace, Seattle, WA (US); Brent Mills, Seattle, WA (US)

Correspondence Address: FITZPATRICK CELLA HARPER & SCINTO, 30 ROCKEFELLER PLAZA, NEW YORK, NY, 10112, US

(73) Assignee: MusicNet

(21) Appl. No.: 11/375,591

(22) Filed: Mar. 15, 2006

(51) Int. Cl. G06F 17/30

(52) U.S. Cl. 707/9

(57) ABSTRACT

System for managing web calls to a computer system including multiple computers. The system monitors the health of the computers for problems which could lead to disruption of service to users. Detected problems are mitigated by dividing the computers into different computer groups and routing users to the different computer groups so as to isolate, in one of the computer groups, a group of users potentially responsible for the problems.

### BACKGROUND OF THE INVENTION

1. Field of the Invention

The present invention generally relates to a system, method, and computer program product for managing an increased volume of web calls or other requests for connection to a computer system (formed with multiple computers), which volume (or other problem) may lead to compromised system performance. More particularly, the present invention relates to managing increased user traffic or other strain on the system by dividing available computers, used for forming user connections, into separate groups; furthermore, different groups of users are selectively directed to the different computer groups, preferably based on predetermined criteria, to protect one or more groups from the compromised system performance.

2. Related Art

There are many existing web-based content providers, which operate computer systems that provide content to users/subscribers, usually for a fee. Typically, such providers offer video and/or audio content, to be streamed to the users in real time or downloaded as individual files to a user's computer for storage and subsequent playback. Other content may include e-books, software, games or other digital content.

Often, these are subscription services in which a user pays a monthly, for instance, subscription fee in exchange for unlimited access to the content offered by that provider (e.g., the unlimited streaming or downloading of songs). In other business models, videos or songs are offered individually for purchase, in which case the user, upon purchase, downloads the content for permanent storage on the user's computer, MP3 player, gaming station, etc.

In most cases, access to the content provider (and hence the catalog of content) is provided over the Internet. Of course, other connections between the users and the content provider are possible, such as modem-to-modem connections, closed networks, and the like. On the Internet, such services may be provided and managed by a known content provider with an established base of users, such “i-Tunes” from Apple®. In other situations, an established content provider may contract with an outside service to provide and manage the content. In such cases, the user interface may be designed or masked such that the user is not even aware that a subcontractor (typically operating from a different web address) is actually providing the content.

In either case, the established/primary content provider or contractor (both of which may be generically referred to throughout this application as the content provider) is charged with effectively and efficiently providing users with reliable access to the content. This requires initiating and managing a large volume of connections with various users (i.e., web calls to the computer system of the content provider) and maintaining connectivity with or availability to those users. To provide a high quality service, the content provider must keep queue times short so that the user can quickly access and download content without long wait times or significant service disruptions.

As discussed, users typically contact the service providers via Internet connections. In some systems, the software is completely web based such that all of the program applications are run on the provider's web site. This is more common with the streaming of music or video. In other systems, the user downloads program applications that are run on the user's computer. The program applications may be used to provide a user interface which allows for connection to the content provider's computer system, downloading of the content to an assigned memory, management of the downloaded content files, and playback of those content files, for example. Examples of such software include Rapsody from Real Networks® and iTunes from Apple®.

In systems where a contractor is used to provide the content, the user-end program application may be designed to directly contact the contractor's computer system, bypassing the user's primary content provider, although this interaction may be hidden from the user. For instance, the user may be a Yahoo!® customer who may download a program application for using Yahoo!'s® music service. However, Yahoo!® may subcontract the music service to a contractor with an existing music service. Thus, the downloaded program application, while expressing a Yahoo!® interface, may directly connect with the contractor for the downloading of music without the user being aware of the contractor's role.

Such a contractor may receive web calls from users associated with a number of different primary content providers. In partnering with these primary content providers, there are contract negotiations which may result in the contractor agreeing to certain requirements with respect to the level of service to be provided to the users (the primary content provider's customers). For instance, a primary content provider may require that the contractor provide 99.9% accessibility/availability to the users. This could refer to the percentage of the time during which the users will have uninterrupted access. In other words, the percentage of time a web connection is available to a user attempting to log in to the music service. It could also be measured in other ways, such as the amount of time during which a user can access the computer system within a predetermined wait/queue time. Other requirements may be negotiated as well. For instance, there may be requirements concerning maximum response times and the like.

Because a contractor typically negotiates each contract separately, there may be different requirements negotiated for different groups of users. Specifically, the customers of different primary content providers may be afforded different minimum service assurances. Thus, the contractor may wish to account for the services provided to different users in different manners. For instance, if the availability of the system is being pushed to the limit, in maybe advantageous for the contractor to show a preference to users associated with a particular primary content provider whose contract requires a higher minimum accessibility for its customers, over other clients who may not being paying the same premium for the service or who have a less favorable contract.

In other situations, if the primary content provider is providing the music service (rather than using a contractor), the content provider may offer different levels of service to its own customers. In such a case, the content provider may wish to provide enhanced accessibility to the customers paying for a premium service, as compared to users paying a lesser amount for a basic service.

Consequently, in the event a computer system, used to provide content to customers over a network such as the Internet, is pushed to near its maximum capacity because of a flood of requests from users (or otherwise stressed), it would be advantageous if the system could manage the customers' requests in such a way as to protect, at least partially, preferred clients from possible disruptions in service or decreased availability of access to the system.

### BRIEF DESCRIPTION OF THE INVENTION

The present invention meets the above-discussed needs by providing a system, method, and computer program product for managing a high volume of incoming traffic so as to preserve system availability/accessibility for at least a particular group of users.

An advantage of the present invention is that, in one embodiment, it provides a system of detecting a drain on a computer system's capacity (due to increased volume of web calls, connectivity volume, computers being shut down for servicing, etc.) and, in response, routes users in a manner so as to reduce the chances of reduction in accessibility for at least one group of users. Thus, resources are reallocated based on the operator's and customers' needs.

Another advantage of the present invention is the provision of a system that, upon detection of high traffic volume or other problem(s) that suggest the risk of diminished accessibility or other potential degradation in the customer's experience, divides the system's resources into multiple system groups or queues, with different groups of customers being directed to the different ones of the system groups in a defined manner. By so doing, the groups of customers may be defined based on preference levels or their perspective impact on the system, so that at least one customer group is provided greater (or lesser) resources than one or more other groups of customers. Therefore, the accessibility for preferred customers or customers not responsible for the drain on the system may be maintained when risks to the computer system are detected, or customers primarily responsible for the problems may be isolated.

Another advantage of the present invention is that it can be used to route customers to a different bank of computers at a separate computer system or data centers. This can be used when one data center is being closed for servicing, there is an impending storm that could affect operations at one data center, the business is moving locations, etc. Thus, the invention could be used for geographical moves between different computer systems in addition to moves within a given computer system.

A preferred embodiment of the present invention is a method of managing incoming client call traffic to a computer system having a plurality of computers. The method includes a step of receiving incoming calls from multiple clients and routing the incoming calls to different ones of the plurality of computers, such that each call is routed to a single one of the plurality of computers. In addition, there is a step of monitoring performance levels of the computer system, and providing an alert when one or more of the monitored performance levels indicates client accessibility to the computer system may be compromised. Furthermore, in response to the alert, the plurality of computers are divided into at least two different computer groups, and different clients are directed to different ones of the at least two different computer groups.

### BRIEF DESCRIPTION OF THE DRAWINGS

FIG. 1A is a schematic drawing of a computer system according to one embodiment of the present invention.

FIG. 1B is a schematic drawing of a section of detail of the computer system shown in FIG. 1A.

FIG. 2 is a flow chart showing the steps of one method according to an embodiment of the present invention.

### DETAILED DESCRIPTION OF THE INVENTION

I. Overview

The present invention is directed to a system, method, and computer program product for managing incoming user traffic to a computer system in which risks of diminished accessibility or other potential degradation of service are detected and mitigated by dividing system resources in such a manner so as to shield at least one group of users from the problem.

The terms “user,” “customer,” and “client” are used interchangeably throughout this application to refer to persons or entities capable of accessing and using a computer system in an embodiment of the present invention. As will be appreciated by one of ordinary skill in the art, a user will typically access the computer system from his/her own computer device or using his/her account information. Often in this application, the term user will be used to refer to the person or entity itself and/or the user's computer device. The term “content provider” is used herein to refer to both the primary content provider and the contractor discussed above. Furthermore, the term “content” as used herein is discussed most often with respect to music or video files; however, the term should be understood to encompass any form of downloadable data, including, for instance, music, video, games, e-books, software, digital pictures, etc.

The present invention may be implemented using hardware, software or a combination thereof and may be implemented in one or more computer systems or other processing systems. The manipulations performed by the present invention are often referred to as comparing, determining, or the like, which are commonly associated with mental operations performed by a human operator. It will be appreciated that these actions may be performed by a human, a computer (i.e., digital computers and the like), or some combination thereof.

II. System

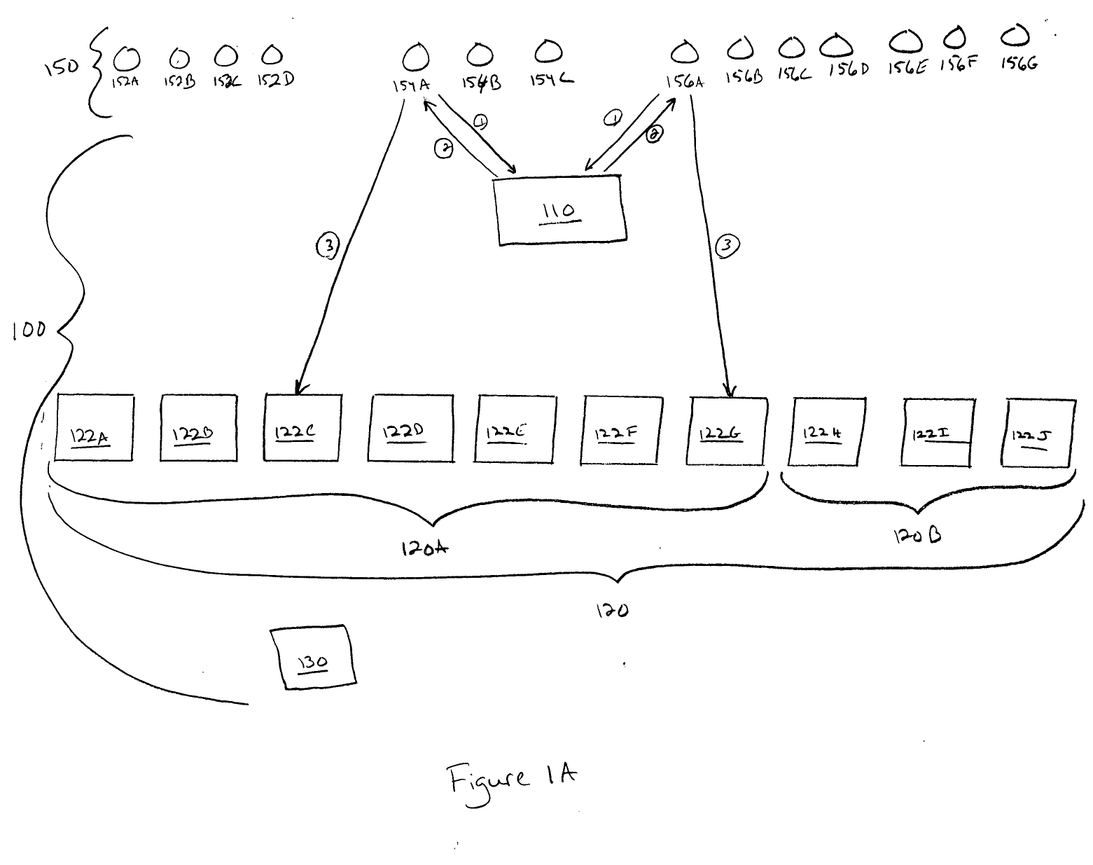

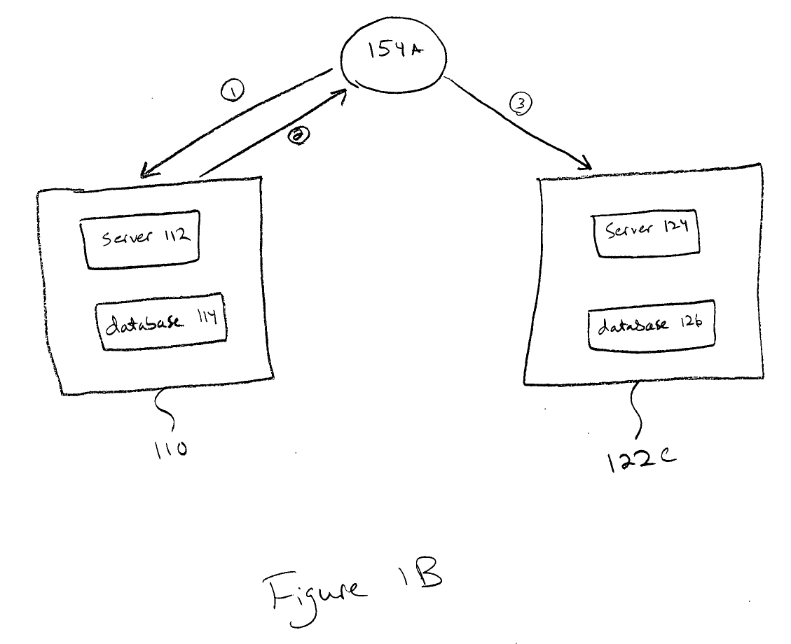

In a preferred embodiment, the present invention is directed to a system of computers such as computer system 100, shown in FIG. 1A, for providing content over data connections to users. In most embodiments, the connections will be web-based connections, which will be discussed in the following examples. Other data connections may also be used.

Thus, in the present embodiment, computer system 100 receives web calls from users, manages the connections with the users (more specifically, with the users' computer devices), and provides the necessary content for downloading in an efficient manner.

Computer system 100 includes a group of computers 120, including computers 122A-J. The computers may be desktop computers, servers, mainframes, and the like, although in preferred embodiments the computers are individual servers. Each computer 122 receives web calls from users and sets up connections with the users to provide content by downloading or the like. Preferably, each computer is located at a different web address and operates to manage web calls coming to that address by forming a queue, logging in customers, identifying customers, managing customers' accounts, responding to requests for content, tracking and storing the usage patterns of those customers, etc. In this regard, it is preferred that each computer 122 perform redundant functions, compared to the other computers, so that each computer 122 can provide a complete set of services to the customers directed to that computer (i.e., to that particular URL serviced by the computer 122).

Computer system 100 also includes switchboard 110. Switchboard 110 may also be a server system or other computer. Preferably, it is a bank of computers (each capable of routing users) with an IP queue for managing the load across the computer. Switchboard 110 is preferably provided at a primary web address for the computer system 100, which address users first contact when attempting to log in. Switchboard 110 provides necessary hardware and software for handling those incoming web calls and redirecting the traffic to computers 122A-J, for appropriate servicing. Typically, the redirecting is accomplished by providing the connecting user with an alternative URL which the user then contacts to begin a connection session. The routing of calls is shown with arrows 1, 2, and 3, which depict a connection attempt into system 100. Specifically, with respect to user 154A, a call from the user (arrow 1) first goes to the URL of switchboard 110, which responds, shown by arrow 2, with instructions to contact another URL. Arrow 3 depicts the call by user 154A to the new URL provided by switchboard 110, which, in this case, corresponds to computer 122C.

This may be handled automatically such that switchboard 110 provides instructions to the user's computer to contact the alternate web address for service, preferably in a seamless manner such that the user is not even aware of the rerouting. In other embodiments, switchboard 110 may also provide content services like computers 122A-J, if necessary. However, in a preferred embodiment, switchboard 110 merely acts as a gatekeeper for monitoring and redirecting traffic in an orderly manner so as to maintain an even distribution of web traffic and connections across the computers 122A-J.

As shown in FIG. 1B, in this embodiment, switchboard 110 includes server 112 and database 114. Server 112 may comprise appropriate hardware and software for handling the incoming web traffic and managing and redirecting it as appropriate. Database 114 may include client information, such ID's identifying the particular users requesting sessions. Preferably, the ID will include both user identification information and retailer identification information. The user ID information may identify the particular user (or account) and the retailer ID information may identify the primary content provider with which that user (or account) is affiliated (i.e., the partner through which the user has subscribed to the service). The ID may be a name and password that the user enters to start a session, a cookie or the like stored on the user's computer, code embedded in a program application provided on the user's computer, or the like.

In other embodiments, database 114 may also include actual content, where switchboard 110 operates as a content-providing mechanism in addition to a routing mechanism. As will be appreciated by one of ordinary skill in the relevant art, database 114 may include additional information necessary to allow it to perform the necessary functions of receiving, managing, and routing users. A user may be required to log in at switchboard 110, or the log in may take place at the computer 122 to which the user is redirected. The user then forms a connection with the assigned computer 122 for the entirety of that particular session. Once the session has ended (by the user logging out or the session being timed out), when the user next contacts the computer system 100, the user again reaches switchboard 110 in order to be rerouted again to one of computers 122A-J.

As shown in FIG. 1A, the depicted embodiment includes computers 122A-J; however, in other embodiments, any number of computers may be provided to handle the web traffic for computer system 100. As shown in FIG. 1B, in this embodiment, each computer includes a server 124 and a database 126. The server 124 includes appropriate hardware and software for logging in the user, maintaining a web connection with the user, forming a queue, if necessary (although a queue may be formed by a separate component in front of the computer or group of computers), providing content to the user based on user requests, tracking use (including billing issues and user preferences), streaming content to the user's computer, etc. The database 126 includes the content, for instance, the videos or music tracks which a user may request and download, as well as user and retailer information indicating or identifying a particular user and affiliated partner. The database may also store information concerning billing and usage. The maintenance and operation of such databases, as well as the necessary content, would be readily understood by one of ordinary skill in the art given conventional systems. Operating software may include those provided by Apple®, Windows®, Sun Microsystems®, etc.

As shown in FIG. 1A, computers 120 are divided into groups 120A and 120B. These different groups form different queues in order to handle different groups of users, as will be discussed in more detail below. Consequently, switchboard 110 may direct different users to different ones of the groups 120A and 120B such that the users being routed to any one group of computers are predetermined based on a defined set of rules.

FIG. 1A shows users 150. In the depicted embodiment, the users are divided into user groups 152, 154, and 156. The different groups can be based on the associated primary content provider (i.e., the entity through which the user has contacted the computer system 100 of a contractor). For instance, group 152 may be users that are all Yahoo!® clients, while group 154 may be all Microsoft® clients. In other embodiments, the different groups may represent different membership levels for the users. For instance, a subscription service may offer different levels of membership such as a premium membership and a base level membership, with the premium users being afforded enhanced benefits, perhaps including accessibility to the system.

When referring to users 150, it will be understood by one of ordinary skill in the art that these users are connecting to computer system 100 from other computer devices. Preferably, these devices have stored thereon program applications that provide interfaces for dealing with computer system 100 and enable the connection to computer system 100 over the Internet. Also, preferably, such program applications on the computers of users 150 include identification information, preferably including user identification and retail identification information. The program application also may help the user organize, manage, and play content downloaded from computer system 100. Such program applications for downloading and managing content are known in the art. Any one of a number of different systems may be used to accomplish the functionality discussed herein.

Computer system 100 also includes a monitoring server 130, as shown in FIG. 1A. Monitoring server 130 monitors the health of computer system 100. Preferably, such monitoring includes the tracking of memory availability, CPU availability, database connectivity, queue times, network usage, drop rates, maximum response times, etc. Conventional monitoring software is well known to those of ordinary skill in the art and is commercially available from a number of sources. Such software can be used in connection with the present invention. Also, conventional operating systems often have built in functionality for tracking such information, which then may be stored in log files in the computer running the operating system. Monitoring server 130 may query each computer for such information, in order to perform the monitoring functions.

Monitoring server 130 monitors relevant criteria in order to determine increases in connectivity, decreased CPU availability, and the like, which may indicate increased traffic to computer system 100 or some other problem suggesting a risk to system resources. If the increased traffic, for instance, crosses a threshold at which the operator may wish to be alerted, an alert may be provided. The criteria for issuing such alerts may be predetermined in the software or set by an operator/administrator. Also, the alert may be an action event at which point a mitigating action is taken, rather than a visual or audible alert/cue to an administrator. In any event, the monitoring software operating on monitoring server 130 may provide an alert once a threshold is reached indicating a high risk that computer system 100 may fail to provide adequate accessibility for users 150. This may be defined based on the accessibility required by partner contracts, or otherwise defined.

Consequently, the alert provided by monitoring system 130 indicates to the operator that system resources are potentially being compromised and actions may need to be taken to ensure that accessibility, at least for a specified group of users, is maintained at appropriate or required levels. Preferably, monitoring server 130 also has the ability to allow an operator to divide computers 120 into two or more groups, such as groups 120A and 120B. In other embodiments, this function may be provided by alternative hardware and/or software. Once the computers 120 are divided into two or more groups, the operator can assign different user groups (e.g., groups 152, 154, and 156), to particular computer groups for content access.

For instance, in response to an alert by monitoring server 130, an operator may program switchboard 110 (perhaps through monitoring server 130) to direct users from groups 152 and 154 to computer group 120A, while directing users from user group 156 to computer group 120B. Thus, switchboard 110 would route all future incoming traffic in accordance with the rules defined by the operator. As discussed, these divisions of user groups and computer groups may be provided in accordance with any one of a number of preferences, but typically will be used to maintain enhanced accessibility for a preferred group of users.

In a preferred embodiment, it is up to the operator to divide the computers as needed into two or more groups, and to define the users or groups users to be routed to those different computer groups.

While the discussion above considers that the division of users and computers is done manually by an operator, in other embodiments one or more of these functions may be performed automatically in accordance with a rules package operating on monitoring server 130, or elsewhere in the computer system. For instance, the rules package may be software which detects a problem or potential problem in accessibility and reacts thereto. The system may also detect the possible reasons for the problem, for instance, a high volume of traffic from users affiliated with a particular partner. The rules package may define routing procedures to isolate the problem (for instance, to isolate the high volume partner's customers so that they will not affect the accessibility of the rest of the users) or to provide enhanced accessibility for preferred customers. Thus, the rules package may be defined to divide the users as necessary, divide the computers as necessary, and assign the different groups of users to the different groups of computers to maintain enhanced accessibility for at least one group of users. Furthermore, the rules package may have rules to define when the system will go back to normal operating conditions once the monitoring server 130 determines that the flow of traffic has normalized to an acceptable level.

III. Method

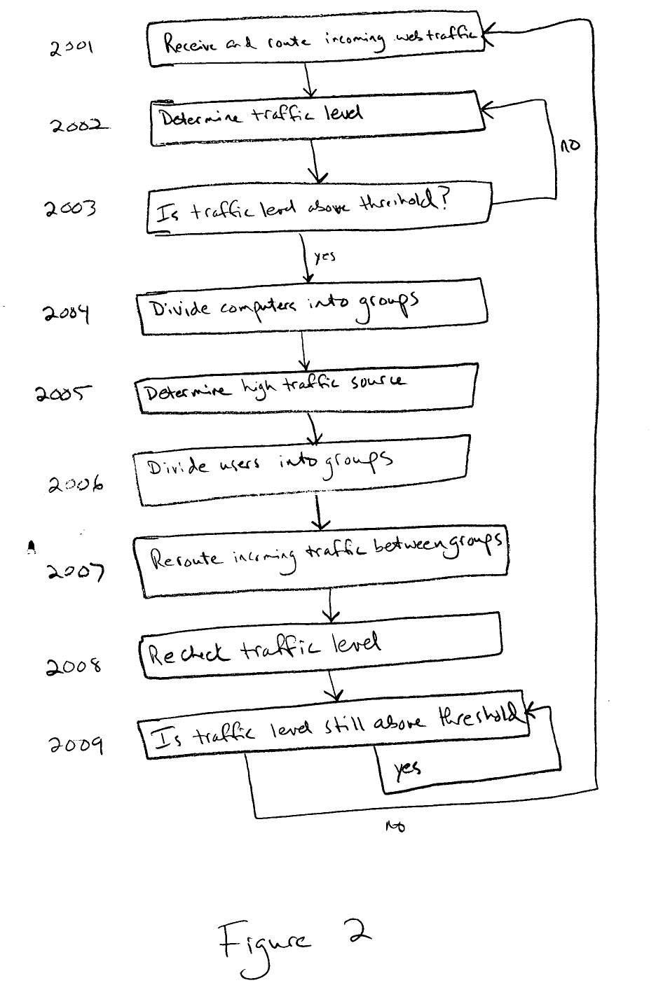

A preferred method of one embodiment of the invention is described below with respect to FIG. 2. The method is for managing a computer system for receiving web calls from users in search of content to be downloaded. In this embodiment, the computer system controlled with this method comprises twenty computers, a switchboard for receiving initial web calls from users and rerouting them to the various computers for servicing of the users' requests, and a monitoring device for monitoring traffic levels across the computer system.

As shown in FIG. 2, in step 2001, the computer system receives initial web calls from users and the switchboard reroutes each call to one of the twenty computers so as to spread the call volume evenly across the twenty computers. In step 2002, the monitoring device checks the incoming traffic level of the system. This is accomplished by measuring the number of incoming calls to the switchboard over the last 30 seconds.

In step 2003, there is a determination made as to whether the incoming traffic level measured in step 2002 is above a predetermined threshold level. If the level is not above a threshold, the process returns to step 2002, where the traffic level is checked again. If the traffic volume is above the threshold level, the process proceeds to step 2004.

In step 2004, the twenty computers are divided into two groups of computers. The first group consists of three computers. The second group consists of seventeen computers. In step 2005, it is determined which partner, out of a predetermined group of partners, has the highest number of affiliated users in the volume of web traffic detected in step 2002. In step 2006, the users are divided into two user groups. The first user group consists of all users affiliated with the partner with the highest number of users detected in step 2005. The second user group includes all other users. Preferably, the predetermined group in step 2005 excludes partners with preferred status, due to contract agreements or the like.

In step 2007, the switchboard is controlled to route all future incoming web calls from users of the first user group to the first computer group, and all incoming web calls from users of the second user group to the second computer group. Preferably, the switchboard routes the web calls so as to evenly distribute the calls within each of the computer groups. Thus, users affiliated with the partner at least partially responsible for the high traffic volume are isolated on three computers, so that their high volume traffic does not affect other users. This reduces risks to accessibility for the other users and allows the contractor to fulfill contract requirements for those respective other users.

In step 2008, the traffic volume is rechecked. In step 2009, it is determined whether the total traffic volume checked in step 2008 is still above the threshold level. If the traffic volume is no longer above the threshold level, the system resets itself to its initial state (i.e., removes the group settings) and return to step 2001. If the traffic volume is still above the threshold level, the process returns to step 2007. In other embodiments, however, the process could be designed such that, even if the traffic volume is above the threshold level, the process could return to step 2001, but without returning the group settings to the initial states. By so doing, the group settings can be further divided, as necessary, to handle new stresses to the system, while still addressing the initial stress. For instance, another partner's customers could flood the system, in which case it may be preferable to divide the computers again to form three groups, two of which would be used to isolate the customers of the two high traffic partners.

With this example method, a potential service disruption due to increased traffic volume is detected, the partner likely responsible for the increase is identified, and the users affiliated with that partner are isolated, so as not to affect the service to users affiliated with other partners. Thus, if the high volume users overload the system, it only affects the three computers on which they are isolated. Furthermore, because only predetermined partners are checked for their effect on traffic volume, partners with preferred contracts can be excluded from such isolation.

IV. Conclusion

While various embodiments of the present invention have been described above, it should be understood that they have been presented by way of example, and not limitation. It will be apparent to persons skilled in the relevant art(s) that various changes in form and detail can be made without departing from the spirit and scope of the present invention. Thus, the present invention should not be limited by any of the above-described examples, but should be defined only in accordance with the following claims and their equivalents. In addition, it should be understood that the attached figures are presented for example purposes only. The architecture of the present invention is sufficiently flexible and configurable, such that it may be organized and utilized in ways other than that shown in the those figures.

We claim:

1. A method of managing incoming client call traffic to a computer system comprising a plurality of computers, the method comprising the steps of:
receiving incoming calls from multiple clients and routing the incoming calls to different ones of the plurality of computers, such that each call is routed to a single one of the plurality of computers;
monitoring performance levels of the computer system;
providing an alert when one or more of the monitored performance levels indicates client accessibility to the computer system is at risk of being compromised; and
in response to the alert, dividing the plurality of computers into at least two different computer groups, and directing different clients to different ones of the at least two different computer groups.

2. The method according to claim 1, wherein each of the multiple clients has an identifier which is used to define membership in one of at least two different client groups, comprising a first client group and a second client group, and clients of the first client group are directed to one of the computer groups and clients of the second client group are directed to a different computer group.

3. The method according to claim 2, wherein a determination of (i) a manner in which to divide the plurality of computers into the different computer groups and (ii) which client groups are to be directed a particular computer group, is manually determined by an operator in response to the alert.

4. The method according to claim 2, wherein the dividing of the plurality of computers into at least two different computer groups is performed automatically by the computer system in accordance with a predetermined set of rules.

5. The method according to claim 4, wherein the alert is an automatic trigger which triggers the dividing of the computers into at least two different computer groups in accordance with the predetermined set of rules.

6. The method according to claim 2, wherein each identifier identifies an entity with which the client is affiliated, and all of the clients affiliated with at least one entity are provided in the first client group.

7. The method according to claim 2, wherein the first client group is a client group with a preferred status, and the one computer group to which the first client group is directed has more computers than the different computer group to which the second client group is directed.

8. The method according to claim 2, further comprising a step of providing content requested by the clients through at least one of streaming and downloading.

9. The method according to claim 8, wherein the content comprises music.

10. The method according to claim 2, wherein the alert is provided when incoming call traffic volume exceeds a predetermined threshold.

11. A computer system for receiving and managing incoming client call traffic, the computer system comprising:
a plurality of computers;
a switchboard for receiving incoming calls from multiple clients and routing the incoming calls to different ones of the plurality of computers, such that each call is routed to a single one of the plurality of computers; and
a monitoring computer for monitoring performance levels of the computer system and providing an alert when one or more of the monitored performance levels indicates client accessibility to the computer system is at risk of being compromised,
wherein, in response to the alert, the plurality of computers are divided into at least two different computer groups, and the switchboard directs different clients to different ones of the at least two different computer groups.

12. The computer system according to claim 11, wherein each of the multiple clients has an identifier which is used to define membership in one of at least two different client groups, comprising a first client group and a second client group, and the switchboard recognizes the identifier and, based on the recognitions, directs clients of the first client group to one of the computer groups and clients of the second client group to a different computer group.

13. The computer system according to claim 12, wherein the computer system receives and input from an administrator indicating a determination of (i) a manner in which to divide the plurality of computers into the different computer groups and (ii) which client groups are to be directed a particular computer group.

14. The computer system according to claim 12, wherein the computer system automatically performs the dividing of the plurality of computers into at least two different computer groups, in accordance with a predetermined set of rules.

15. The computer system according to claim 14, wherein the alert from the monitoring computer is an automatic trigger which triggers the dividing of the computers into at least two computer groups in accordance with the predetermined set of rules.

16. The computer system according to claim 12, wherein each identifier identifies an entity with which the client is affiliated, and the switchboard recognizes the identifier and includes all of the clients affiliated with at least one entity in the first client group.

17. The computer system according to claim 12, wherein the first client group is a client group with a preferred status, and the one computer group to which the first client group is directed has more computers than the different computer group to which the second client group is directed.

18. A computer-executable program product, embodied in a computer-readable medium, having code for instructing a computer to perform a method of managing incoming client call traffic to a computer system comprising a plurality of computers, the method performed by the program product comprising the steps of:
receiving incoming calls from multiple clients and routing the incoming calls to different ones of the plurality of computers, such that each call is routed to a single one of the plurality of computers;
monitoring performance levels of the computer system;
providing an alert when one or more of the monitored performance levels indicates client accessibility to the computer system is at risk of being compromised; and
in response to the alert, dividing the plurality of computers into at least two different computer groups, and directing different clients to different ones of the at least two different computer groups.

19. The computer-executable program product according to claim 18, wherein each of the multiple clients has an identifier which is used to define membership in one of at least two different client groups, comprising a first client group and a second client group, and clients of the first client group are directed to one of the computer groups and clients of the second client group are directed to a different computer group.

20. The computer-executable program product according to claim 19, wherein a determination of (i) a manner in which to divide the plurality of computers into the different computer groups and (ii) which client groups are to be directed a particular computer group, is manually determined by an operator in response to the alert.

21. The computer-executable program product according to claim 19, wherein the dividing of the plurality of computers into at least two different computer groups is performed automatically by the computer system in accordance with a predetermined set of rules.

22. The computer-executable program product according to claim 21, wherein the alert is an automatic trigger which triggers the dividing of the computers into at least two different computer groups in accordance with the predetermined set of rules.

23. The computer-executable program product according to claim 19, wherein each identifier identifies an entity with which the client is affiliated, and all of the clients affiliated with at least one entity are provided in the first client group.

24. The computer-executable program product according to claim 19, wherein the first client group is a client group with a preferred status, and the one computer group to which the first client group is directed has more computers than the different computer group to which the second client group is directed.
